(19) United States
(12) Patent Application Publication
(10) Pub. No.: US 2012/0226779 A1
(43) Pub. Date: Sep. 6, 2012

(54) AUTOMATIC ENTRY OF CALENDAR EVENTS

(75) Inventor: Kevin M. Crucs, Copley, OH (US)

(73) Assignee: CRUCS HOLDINGS, LLC, Copley, OH (US)

(21) Appl. No.: 13/040,319

(22) Filed: Mar. 4, 2011

(51) Int. Cl. G06F 15/16; G06F 17/00

(52) U.S. Cl. 709/219; 235/375

(57) ABSTRACT

Devices, methods, servers, and non-transitory computer-readable medium for automatically generating an event entry within an electronic calendar application. An event-identifying code of an advertised event is entered into an electronic auto-event feature running on a processor-based device. The auto-event feature may automatically access an event server via an information network in response to the event-identifying code and automatically retrieve event information associated with the advertised event from the event server via the information network based on at least a portion of the event-identifying code. Alternatively, the event information may be embedded in the event-identifying code. The auto-event feature is in operative communication with an electronic calendar application running on a processor-based device to automatically create at least one event entry for the advertised event within the electronic calendar application using at least a portion of the event information.

### TECHNICAL FIELD

Certain embodiments of the present invention relate to the automatic entry of information into a software application. More particularly, certain embodiments of the present invention relate to systems and methods to facilitate the automatic entry of upcoming events into a calendar application.

### BACKGROUND

Today, more often than not, people have to manually create events in their electronic calendar applications. In a non-work environment, these events may include, for example, entertainment shows such as concerts or sporting events, upcoming lectures, tradeshows, and special shopping events. When creating these events in an electronic calendar application, people may have to enter times, dates, descriptions, and possibly other associated information. Such manual entry takes time and can be prone to mistakes made by the user such as, for example, entering the wrong time for the event or failing to enter some critical information associated with the event. A need exists for a more efficient and effective way to create events in an electronic calendar application.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

Embodiments of the present invention facilitate the automatic entry of events into an electronic calendar application of a user.

An embodiment of the present invention comprises a method for automatically generating an event entry within an electronic calendar application. The method includes entering an event-identifying code of an advertised event into an electronic auto-event feature running on a processor-based device. The event-identifying code may be, for example, a one-dimensional bar code, a two-dimensional bar code, or alpha-numeric characters. The auto-event feature automatically accesses an event server via an information network in response to the event-identifying code and automatically retrieves event information associated with the advertised event from the event server via the information network based on at least a portion of the event-identifying code. The auto-event feature is in operative communication with an electronic calendar application running on a processor-based device to automatically create at least one event entry for the advertised event within the electronic calendar application using at least a portion of the event information. The auto-event feature and the electronic calendar application may both reside on the same processor-based device. Furthermore, the auto-event feature may be an integral part of the electronic calendar application. Alternatively, the auto-event feature and the electronic calendar application may each reside on different process-based devices. The step of entering the event-identifying code may include electronically scanning the event-identifying code off of one of a printed advertisement and a displayed advertisement of the advertised event. As an alternative, the step of entering the event-identifying code may include electronically capturing an image of the event-identifying code off of one of a printed advertisement and a displayed advertisement of the advertised event, and decoding the captured image. As a further alternative, the step of entering the event-identifying code may include electronically capturing an image of the event-identifying code off of one of a printed advertisement and a displayed advertisement of the advertised event, and optically character reading the captured image. Still, a further alternative may include manually keying the event-identifying code into the processor-based device running the electronic auto-event feature. The step of automatically creating at least one event entry for the advertised event within the electronic calendar application may further use a current location of a user of the auto-event feature to choose at least one location of the advertised event from the invent information. The current location of the user may be based on GPS information or cell tower information, for example. Alternatively, the step of automatically creating at least one event entry for the advertised event within the electronic calendar application may further use a known residence address or a known business address of a user of the auto-event feature to choose at least one location of the advertised event from the event information.

Another embodiment of the present invention comprises a non-transitory computer-readable medium having computer-executable instructions for enabling the performance of a method for automatically generating an event entry within an electronic calendar application. The method includes receiving an event-identifying code of an advertised event and automatically accessing an event server via an information network in response to the event-identifying code. The event-identifying code may be, for example, a one-dimensional bar code, a two-dimensional bar code, or alpha-numeric characters. The method further includes automatically retrieving event information associated with the advertised event from the event server via the information network based on at least a portion of the event-identifying code. The method also includes operatively communicating with an electronic calendar application running on a processor-based device to automatically create at least one event entry for the advertised event within the electronic calendar application using at least a portion of the event information. The event-identifying code may be received as electronically scanned and decoded data, as electronically imaged data, or as electronically imaged and decoded data. Alternatively, the event-identifying code may be received as manually keyed electronic data. The method step of automatically creating at least one event entry for the advertised event within the electronic calendar application may further use a current location of a user of the auto-event feature to choose at least one location of the advertised event from the invent information. The current location of the user may be based on GPS information or cell tower information, for example. Alternatively, the method step of automatically creating at least one event entry for the advertised event within the electronic calendar application may further use a known residence address or a known business address of a user of the electronic calendar application to choose at least one location of the advertised event from the event information.

A further embodiment of the present invention comprises an event server computer storing event information associated with advertised events and hosting computer-executable instructions enabling the performance of a method including receiving an event-identifying code of an advertised event, via an information network, from an auto-event feature running on a processor-based device. The method performed by the server computer further includes reading the event-identifying code and accessing stored first event information associated with at least a portion of the event-identifying code. The method performed by the server computer also includes sending the first event information to the auto-event feature via the information network, wherein the auto-event feature is configured to automatically create an event entry within an electronic calendar application based on the first event information. The method performed by the server computer may further include receiving additional event information associated with other advertised events via the information network, and storing the additional event information for subsequent accessing in response to subsequent event-identifying codes received from the auto-event feature. The method performed by the server computer may also include deleting the first event information from the event server computer after the advertised event has occurred.

Another embodiment of the present invention comprises a processor-based device having computer-executable instructions configured as an auto-event feature for enabling the performance of a method for automatically generating an event entry within an electronic calendar application. The processor-based device may include at least one of a mobile device, a cellular telephone, a laptop computer, and a desktop computer, for example. The method performed by the processor-based device includes receiving an event-identifying code of an advertised event and automatically accessing an event server computer via an information network in response to the event-identifying code. The event-identifying code may be, for example, a one-dimensional bar code, a two-dimensional bar code, or alpha-numeric characters. The method performed by the processor-based device further includes automatically retrieving event information associated with the advertised event from the event server computer via the information network based on at least a portion of the event-identifying code. The method performed by the processor-based device also includes operatively communicating with an electronic calendar application running on a processor-based device to automatically create at least one event entry for the advertised event within the electronic calendar application using at least a portion of the event information. The method step of receiving the event-identifying code may include electronically scanning the event-identifying code from a printed or displayed advertisement, electronically imaging the event-identifying code from a printed or displayed advertisement, or manually keying the event-identifying code into the processor-based device. The method step of automatically creating at least one event entry for the advertised event within the electronic calendar application may further use a current location of a user of the auto-event feature to choose at least one location of the advertised event from the invent information. The current location of the user may be based on GPS information or cell tower information, for example. Alternatively, the method step of automatically creating at least one event entry for the advertised event within the electronic calendar application may further use a known residence address or a known business address of a user of the processor-based device to choose at least one location of the advertised event from the event information.

A further embodiment of the present invention comprises a method for automatically generating an event entry within an electronic calendar application. The method includes entering an event-identifying code of an advertised event into an electronic auto-event feature running on a processor-based device, wherein the event-identifying code includes event information associated with the advertised event. The event-identifying code may be, for example, a one-dimensional bar code, a two-dimensional bar code, or alpha-numeric characters. The method further includes the auto-event feature being in operative communication with an electronic calendar application running on a processor-based device to automatically create at least one event entry for the advertised event within the electronic calendar application using at least a portion of the event information. The auto-event feature and the electronic calendar application may both reside on the same processor-based device. Furthermore, the auto-event feature may be an integral part of the electronic calendar application. Alternatively, the auto-event feature and the electronic calendar application may each reside on different process-based devices. The step of entering the event-identifying code may include electronically scanning the event-identifying code off of one of a printed advertisement and a displayed advertisement of the advertised event. As an alternative, the step of entering the event-identifying code may include electronically capturing an image of the event-identifying code off of one of a printed advertisement and a displayed advertisement of the advertised event, and decoding the captured image. As a further alternative, the step of entering the event-identifying code may include electronically capturing an image of the event-identifying code off of one of a printed advertisement and a displayed advertisement of the advertised event, and optically character reading the captured image. Still, a further alternative may include manually keying the event-identifying code into the processor-based device running the electronic auto-event feature. The step of automatically creating at least one event entry for the advertised event within the electronic calendar application may further use a current location of a user of the auto-event feature to choose at least one location of the advertised event from the invent information. The current location of the user may be based on GPS information or cell tower information, for example. Alternatively, the step of automatically creating at least one event entry for the advertised event within the electronic calendar application may further use a known residence address or a known business address of a user of the auto-event feature to choose at least one location of the advertised event from the event information.

Another embodiment of the present invention comprises a non-transitory computer-readable medium having computer-executable instructions for enabling the performance of a method for automatically generating an event entry within an electronic calendar application. The method includes receiving an event-identifying code of an advertised event, wherein the event-identifying code includes event information associated with the advertised event. The event-identifying code may be, for example, a one-dimensional bar code, a two-dimensional bar code, or alpha-numeric characters. The event-identifying code may be received as electronically scanned and decoded data, as electronically imaged data, as electronically imaged and decoded data, or as manually keyed electronic data. The method further includes operatively communicating with an electronic calendar application running on a processor-based device to automatically create at least one event entry for the advertised event within the electronic calendar application using at least a portion of the event information. The method step of automatically creating at least one event entry for the advertised event within the electronic calendar application may further use a current location of a user of the electronic calendar application to choose at least one location of the advertised event from the event information. The current location of the user may be based on, for example, GPS information or cell tower information. Alternatively, the method step of automatically creating at least one event entry for the advertised event within the electronic calendar application may further use a known residence address or a known business address of a user of the electronic calendar application to choose at least one location of the advertised event from the event information.

A further embodiment of the present invention comprises a processor-based device having computer-executable instructions configured as an auto-event feature for enabling the performance of a method for automatically generating an event entry within an electronic calendar application. The processor-based device may include at least one of a mobile device, a cellular telephone, a laptop computer, and a desktop computer, for example. The method performed by the processor-based device includes receiving an event-identifying code of an advertised event, wherein the event-identifying code includes event information associated with the advertised event. The event-identifying code may include a one-dimensional bar code, a two-dimensional bar code, or alpha-numeric characters. The method step of receiving the event-identifying code may include electronically scanning the event-identifying code from a printed or displayed advertisement, electronically imaging the event-identifying code from a printed or displayed advertisement, or manually keying the event-identifying code into the processor-based device. The method further includes operatively communicating with an electronic calendar application running on a processor-based device to automatically create at least one event entry for the advertised event within the electronic calendar application using at least a portion of the event information. The method step of automatically creating at least one event entry for the advertised event within the electronic calendar application may further use a current location of a user of the processor-based device to choose at least one location of the advertised event from the event information. The current location of the user may be based on GPS information or cell tower information, for example. Alternatively, the method step of automatically creating at least one event entry for the advertised event within the electronic calendar application may further use a known residence address or a known business address of a user of the processor-based device to choose at least one location of the advertised event from the event information.

These and other advantages and novel features of the present invention, as well as details of illustrated embodiments thereof, will be more fully understood from the following description and drawings.

### BRIEF DESCRIPTION OF THE DRAWINGS

FIGS. 1A and 1B illustrate functional block diagrams of example embodiments of mobile processor-based devices having an auto-event feature and an electronic calendar application;

FIG. 2 is a flowchart of an example embodiment of a method for automatically generating an event entry within an electronic calendar application using either of the mobile processor-based devices of FIG. 1A or FIG. 1B;

FIG. 3 illustrates a functional block diagram of an example embodiment of a communication network and a mobile processor-based device having and auto-event feature (AEF) and an electronic calendar application (ECA);

FIG. 4 is a flowchart of an example embodiment of a method for automatically generating an event entry within an electronic calendar application using the communication network and the mobile processor-based device of FIG. 3;

FIG. 5 illustrates a functional block diagram of an example embodiment of a communication network, a mobile processor-based device having an auto-event feature, and a personal computer having an electronic calendar application; and

FIG. 6 illustrates an example embodiment of a communication network and a personal computer having an electronic calendar application and an auto-event feature.

### DETAILED DESCRIPTION

The terms “communication network” and “information network” are used interchangeably herein to refer to any of various wired networks, wireless networks, electronic networks, optical networks, or any combination thereof which facilitates communication of information. The term “application” is used herein to refer to a software application which may be stored on a non-transitory computer-readable medium and which is or may be implemented on a processor-based device such as, for example, a personal computer, a server computer, a tablet computer, and a mobile telephone. The term “feature” is used herein to refer to a particular aspect of an application, or to an application itself. The term “event entry” is used herein to refer to an electronic entry into an electronic calendar application which may include a date, a time, and a location of an upcoming event as well as other information associated with the event.

Electronic calendar applications are well known in the art and allow a user to enter information associated with upcoming events to form event entries within the electronic calendar application. For example, a typical user may desire to enter personal events including business meetings, family member birthdays and anniversaries, and vacations. Electronic calendar applications are often configured with various features including automatic alarmed reminders, for example.

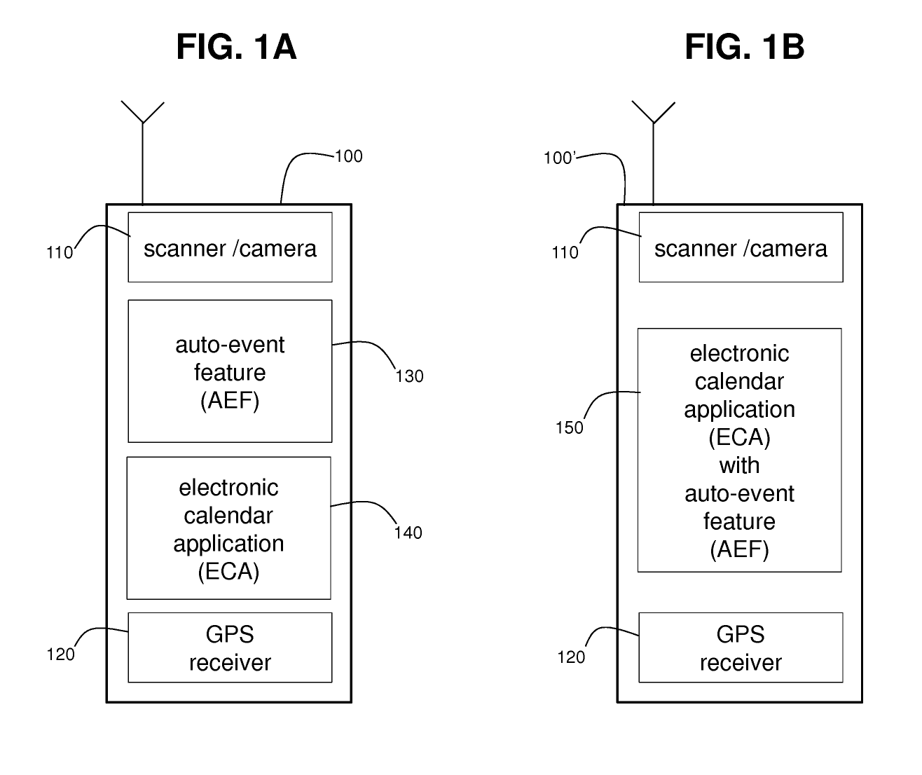

FIGS. 1A and 1B illustrate functional block diagrams of example embodiments of mobile processor-based devices 100 and 100′ having an auto-event feature and an electronic calendar application. The mobile processor-based devices 100 and 100′ may be, for example, cellular telephones, personal digital assistants, or tablet computers having hardware and software configured for performing the various features of a cellular telephone, a personal digital assistant, or a tablet computer. For example, the processor-based devices may include at least one software-programmable microprocessor. The mobile processor-based devices 100 and 100′ are configured for wireless communication with an information network (e.g., a cellular telephone network and the internet).

In FIGS. 1A and 1B, both mobile processor-based devices 100 and 100′ are shown as being configured with a scanner and/or a camera 110, and with a GPS receiver 120. The uses of the scanner/camera 110 and the GPS receiver 120 in the context of the present application are discussed later herein.

The mobile processor-based device 100 of FIG. 1A includes an auto-event feature (AEF) 130 and an electronic calendar application (ECA) 140. In accordance with an embodiment of the present invention, the ECA 140 and the AEF 130 are implemented as software on the device 100. In the mobile processor-based device 100′ of FIG. 1B, the AEF is integrated into the ECA, providing an ECA with an auto-event feature (ECA/AEF) 150. Similarly, the combined ECA/AEF 150 is implemented as software on the device 100′. The AEF is configured to automatically generate an event entry within an ECA as discussed in detail later herein with respect to the remaining figures.

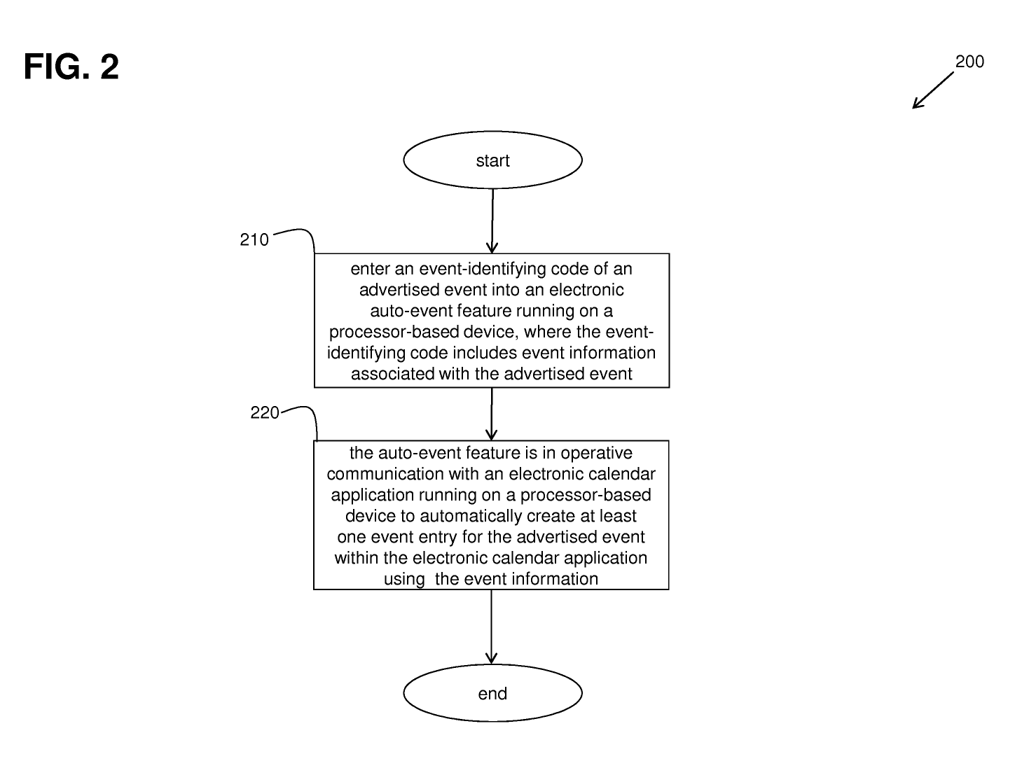

FIG. 2 is a flowchart of an example embodiment of a method 200 for automatically generating an event entry within an electronic calendar application using either of the mobile processor-based devices, 100 of FIG. 1A or 100′ of FIG. 1B. In step 210, an event-identifying code of an advertised event is entered into an electronic auto-event feature (AEF) running on a processor-based device. The event-identifying code includes event information associated with the advertised event. In step 220, the auto-event feature is in operative communication with an electronic calendar application running on a processor-based device to automatically create at least one event entry for the advertised event within the electronic calendar application using the event information. In accordance with various embodiments of the present invention, the AEF and the ECA may operate on the same processor-based device or on different devices.

As an example of the method 200 of FIG. 2, the event-identifying code of an advertised event may be a two-dimensional bar code on a printed or displayed advertisement. Referring to FIG. 1A, the scanner portion of the scanner/camera 110 of the device 100 is used to scan the two-dimensional bar code and the scanned event information is forwarded to the AEF 130. The AEF 130 automatically processes the event information to extract dates, times, locations, and other information (e.g., ticket prices, where to buy tickets) associated with the advertised event, generates an event entry based on the event information, and communicates with the electronic calendar application 140 (e.g., syncs with the ECA 140) to transfer the event entry into the electronic calendar application 140. As a result, the event entry appears in the ECA 140 on the appropriate date along with other relevant information of the advertised event. Furthermore, other previous entries in the ECA 140 are maintained. In accordance with an embodiment of the present invention, the AEF may prompt the user to select the specific portions of the event information that should be included in (or excluded from) the event entry.

In a similar example, the event information scanned from the bar code may already be in the form of an event entry that is acceptable to the ECA 140. As a result, the AEF 130 simply communicates with (e.g., syncs with) the electronic calendar application 140 to transfer the event entry into the electronic calendar application 140. In another similar example, the AEF 130 interactively communicates with the ECA 140 and creates the event entry within the ECA 140, step-by-step, based on the event information as the AEF 130 processes the event information and as the ECA 140 requests entry of various parts of the event entry. In accordance with certain embodiments of the present invention, the means of automatically creating an event entry in an ECA via an AEF may be accomplished using an application program interface (API) or an application event notification message. Other means are possible as well. In general, the AEF 130, having the event information, syncs the event entry to the ECA 140. Such methods of syncing are well known in the art.

In accordance with various embodiments of the present invention, the event-identifying code may be a one-dimensional bar code, a two-dimensional bar code, or alpha-numeric characters. Other types of event-identifying codes are possible as well (e.g., a magnetic strip code). Furthermore, the step 210 of entering an event identifying code may be performed by electronically capturing an electronic image of the event-identifying code using the camera portion of the scanner/camera 110 and decoding the captured image. For example, in one embodiment, the captured image may be optically character read. Alternatively, the event-identifying code may be manually entered by a user of the processor-based device 100 (e.g., via manual keying through a keypad interface of the device 100). Such manual entry may be performed in response to hearing an event-identifying code on the radio, for example.

Sometimes, an advertised event may actually correspond to a series of the same event being at various different locations on various different dates. For example, a performer may be scheduled to appear in ten different cities on ten different dates, according to the advertised event. In accordance with an embodiment of the present invention, the step 220 of creating at least one event entry for the advertised event within the ECA 140 further uses a current location of a user of the processor-based device 100 to choose or select at least one location of the advertised event from the event information.

For example, with respect to the performer mentioned above, if three of the ten cities are considered to be geographically close to the user, then the AEF 130 may extract those three cities and their corresponding dates and other information and enter those three events into the ECA 140 as three different event entries. In this manner, the user does not have to be concerned with the events that are too far away and may choose to attend one of the three more geographically accessible events which is most convenient for the user (e.g., most convenient based on the date of the event).

The current location of the user may be established based on, for example, GPS information received by the GPS receiver 120 of the processor-based device 100. Alternatively, the current location of the user may be established by cell tower information received by the processor-based device 100 (e.g., a location of a current cellular telephone tower of which the device 100 is in range, or with which the device is currently communicating). As a further alternative, a known address of the user (e.g., a residence address or a business address) stored on the device 100 may be used by the AEF 130 as the current location of the user.

As an alternative, the user may be prompted by the AEF to select particular dates and/or locations, for which the user is interested, from the multiple dates and locations of the event. Then, only those dates and locations are included in the event entry (entries). Furthermore, the ECA or AEF may be configured to prompt a user for standard appointment information such as reminder notifications and notes, for example. For example, when the date of an event is approaching, the ECA or AEF may provide a reminder notification to the user in a pop-up window on a display of the processor-based device. Also, the ECA or AEF may prompt a user to add note information to the event entry, for example, at the time the event entry is about to be entered into the ECA, or as the date of the event is approaching.

In accordance with an embodiment of the present invention, the AEF 130 may be stored on a non-transitory computer-readable medium as computer-executable instructions for enabling the performance of the method 200 for automatically generating an event entry within an electronic calendar application. Such non-transitory computer-readable media exclude signals but may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, or any other suitable medium from which a computer can read.

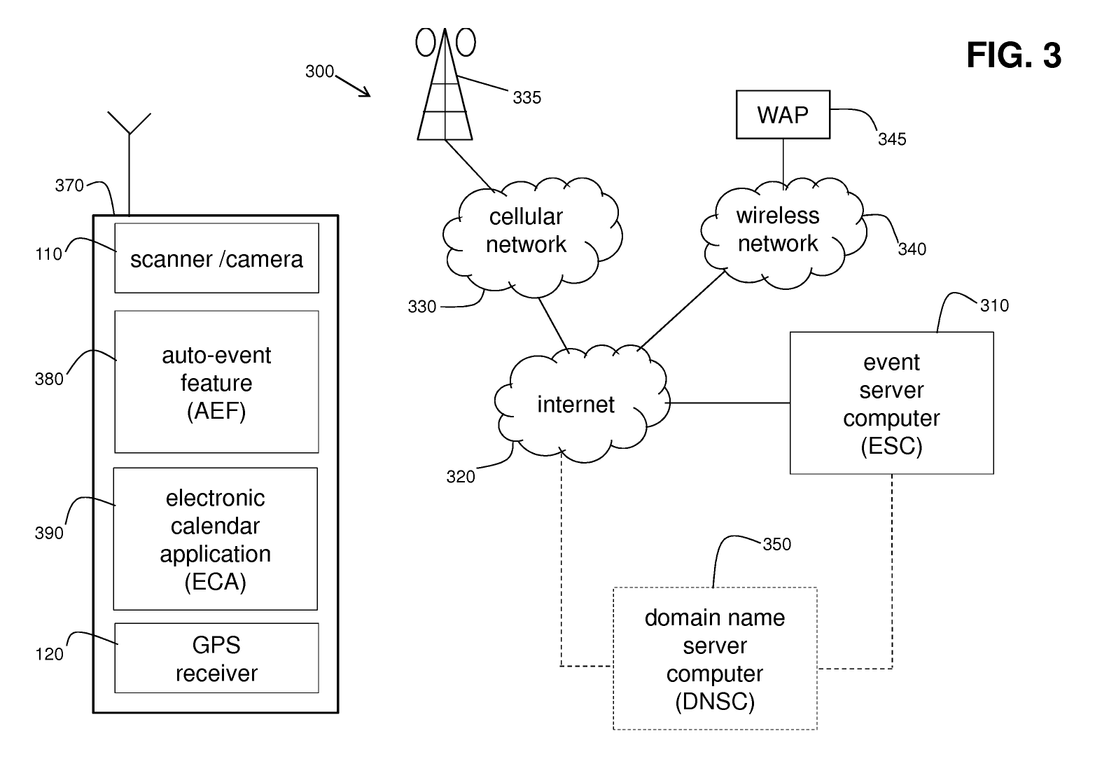

FIG. 3 illustrates a functional block diagram of an example embodiment of a communication network 300 and a mobile processor-based device 370 having and auto-event feature (AEF) 380 and an electronic calendar application (ECA) 390. The device 370 also has a scanner and/or a camera 110 and a GPS receiver 120, similar to that of the device 100 of FIG. 1A. The AEF 380 of the device 370 is configured to communicate with the communication network 300 as is described later herein.

The communication network 300 includes an event server computer (ESC) 310, operatively connected to the internet 320. The communication network 300 also includes a cellular network 330 operatively connected to the internet 320, and at least one cell tower 335 operatively connected to the cellular network 330. The communication network 300 further includes a wireless network 340 operatively connected to the internet 320 and a wireless access point (WAP) 345 operatively connected to the wireless network 340. As an option, the communication network may include a domain name server computer (DNSC) 350 operatively connected between the internet 320 and the event server computer (ESC) 310.

The AEF 380 of FIG. 3 is different from the AEF 130 of FIG. 1A at least in that the AEF 380 is configured to communicate with the communication network 300 to access the event server computer (ESC) 310. The ESC 310 stores event information associated with advertised events, for example, in the form of a database. The ESC 310 also hosts computer-executable instructions enabling the performance of various functions. The various functions of the ESC 310 include receiving an event-identifying code of an advertised event, via the communication network 300, from the AEF 380 running on the processor-based device 370. The various functions of the ESC 310 also include reading the event-identifying code and accessing stored event information associated with at least a portion of the event-identifying code, and sending the event information to the AEF 380 via the communication network 300. The AEF 380 is configured to automatically create an event entry within the ECA 390 based on the event information received from the ESC 310.

The ESC 310 may be a server that accommodates event advertisements for multiple businesses, for example. Alternatively, the ESC 310 may be a server that is owned and operated by a single business and accommodates event advertisements only for that single business. The ESC 310 is managed to add, update, and delete event information associated with advertised events as the situation warrants (e.g., as new events are scheduled and as previous events occur).

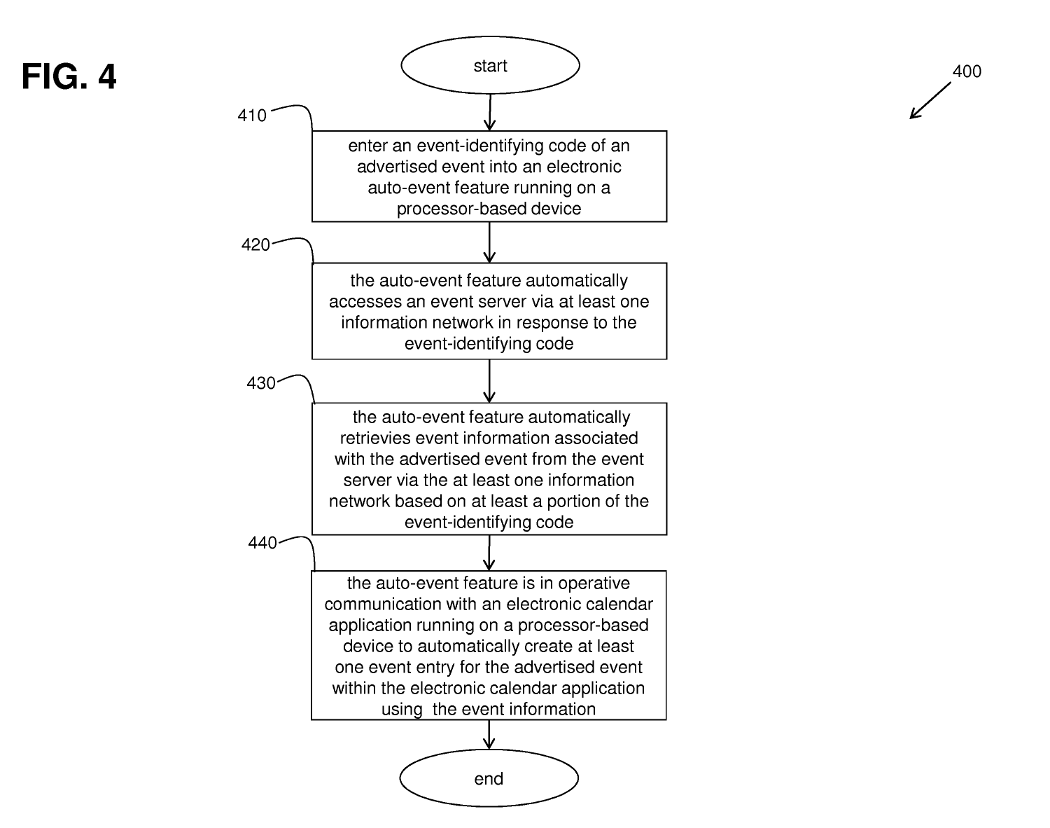

FIG. 4 is a flowchart of an example embodiment of a method 400 for automatically generating an event entry within an electronic calendar application using the communication network 300 and the mobile processor-based device 370 of FIG. 3. In step 410, an event-identifying code of an advertised event is entered into an electronic auto-event feature (AEF) 380 running on a processor-based device 370. As described previously herein, the event-identifying code may be entered via manual keying, scanning, or imaging, for example.

In step 420, the AEF 380 automatically accesses an event server computer (ESC) 310 via at least one information network (e.g., 320 and 330 or 320 and 340) in response to the event-identifying code. In step 430, the AEF 380 automatically retrieves even information associated with the advertised event from the ESC 310 via the at least one information network based on at least a portion of the event-identifying code. In step 440, the AEF 380 is in operative communication with an electronic calendar application (ECA) 390 running on a processor-based device 370 to automatically create at least one event entry for the advertised event within the ECA 390 using the event information.

As an example of the method 400, the processor-based device 370 may be a mobile telephone. A user of the mobile telephone 370 scans or images an event-identifying code from a printed or displayed advertisement. The AEF 380 uses the event-identifying code to access the ESC 310 via the internet 320 through the cell tower 335 and the cellular network 330. The event-identifying code may include an IP address to the ESC 310 or, as an option, may include a domain name which can be interpreted by a domain name server computer (DNSC) 350 which resolves to an IP address of the ESC 310. A portion of the event-identifying code is provided to the ESC 310 and used by the ESC 310 to access stored event information associated with the advertised event. The event information is provided from the ESC 310 to the AEF 380 of the mobile telephone 370 via the internet through the cell tower 335 and the cellular network 330. The AEF 380 uses the event information to automatically create at least one event entry for the advertised event within the electronic calendar application.

As described previously herein, the AEF 380 may automatically process the event information to extract dates, times, locations, and other information associated with the advertised event, generate an event entry based on the event information, and communicate with the electronic calendar application 390 (e.g., sync with the ECA 390) to transfer the event entry into the electronic calendar application 390. As a result, the event entry appears in the ECA 390 on the appropriate date along with other relevant information of the advertised event. Furthermore, other previous entries in the ECA 390 are maintained.

Alternatively, the event information obtained from the ESC 310 may already be in the form of an event entry that is acceptable to and compatible with the ECA 390. As a result, the AEF 380 simply communicates with (e.g., syncs with) the electronic calendar application 390 to transfer the event entry into the electronic calendar application 390. As a further alternative, the AEF 380 interactively communicates with the ECA 390 and creates the event entry within the ECA 390, step-by-step, based on the event information as the AEF 380 processes the event information and as the ECA 390 requests entry of various parts of the event entry. In accordance with certain embodiments of the present invention, the means of automatically creating an event entry in an ECA via an AEF may be accomplished using an application program interface (API) or an application event notification message. Other means are possible as well. In general, the AEF 380, having the event information, syncs the event entry to the ECA 390. Such methods of syncing are well known in the art.

Instead of using the cellular network 330, the processor-based device 370 may access the internet 320 through a wireless network 340 via a wireless access point (WAP) 345. The process of obtaining the event information from the ESC 310 is essentially the same as described above herein, except that access to the internet 320 is through the wireless network 340 instead of the cellular network 330. Again, depending on the nature of the event-identifying code, the ESC 310 may be accessed directly or through a DNSC 350.

Also, as previously described herein, the step 440 of creating at least one event entry for the advertised event within the ECA 390 may further use a current location of a user of the processor-based device 370 to choose or select at least one location of the advertised event from the event information. Again, the current location of the user may be established based on, for example, GPS information received by the GPS receiver 120 of the processor-based device 370. Alternatively, the current location of the user may be established by cell tower information received by the processor-based device 370 (e.g., a location of a current cellular telephone tower of which the device 370 is in range, or with which the device is currently communicating). As a further alternative, a known address of the user (e.g., a residence address or a business address) stored on the device 370 may be used by the AEF 380 as the current location of the user. Other methods of establishing a location of a user are possible as well such as, for example, having the ESC perform event/user location matching, or correlating the event-identifying code to the location where it was scanned or imaged. For example, the event-identifying code may be scanned or imaged off of a particular event location billboard at a theater or a stadium whose location is known and associated with the event-identifying code.

In accordance with an embodiment of the present invention, the AEF 380 may be stored on a non-transitory computer-readable medium as computer-executable instructions for enabling the performance of the method 400 for automatically generating an event entry within an electronic calendar application. Such non-transitory computer-readable media exclude signals but may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, or any other suitable medium from which a computer can read.

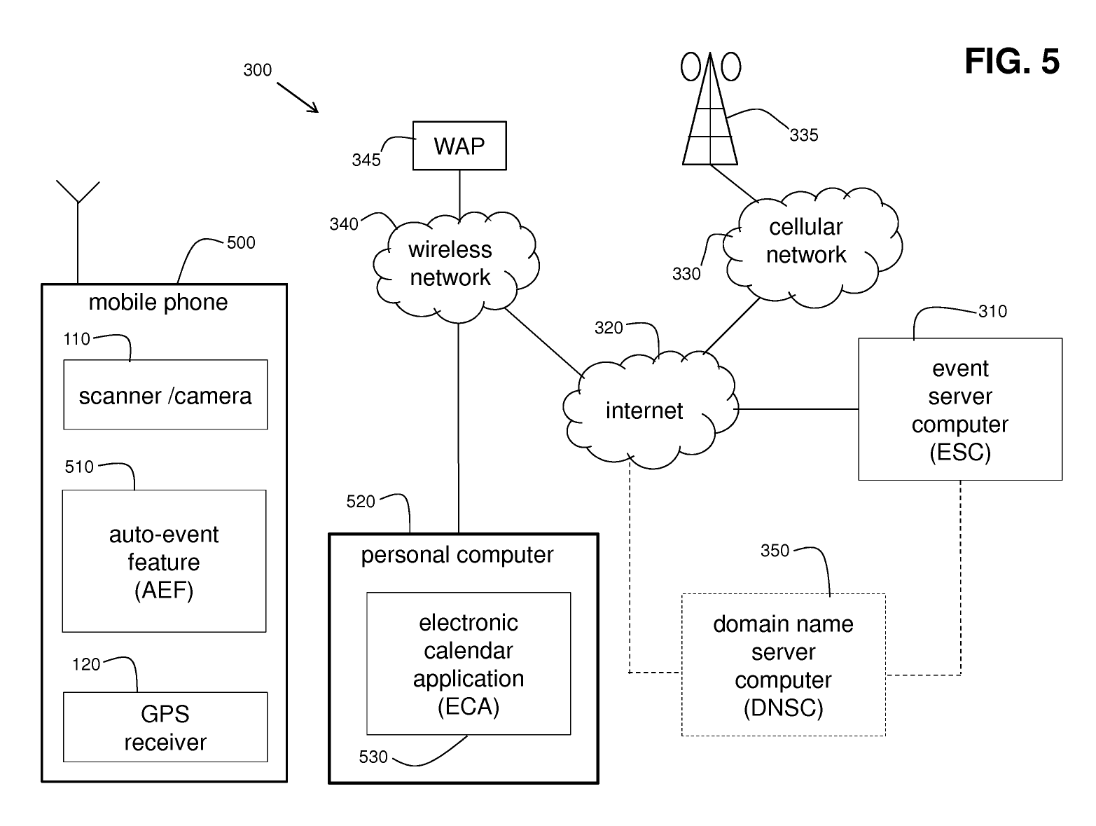

FIG. 5 illustrates a functional block diagram of an example embodiment of a communication network 300, a mobile processor-based device 500 having an auto-event feature 510, and a personal computer 520 having an electronic calendar application 530. The mobile processor-based device 500 is similar to the mobile processor-based device 370 of FIG. 3 except that the electronic calendar application (ECA) 530 resides on the personal computer 520 instead of on the device 500. The AEF 510 functions and operates in the same manner as the AEF 380 of FIG. 3 in terms of receiving an event-identifying code and accessing the event server computer (ESC) 310. However, with respect to creating event entries within the ECA 530, the AEF 510 of the device 500 communicates with the personal computer (PC) 520.

Communication between the mobile phone device 500 and the PC 520 may be achieved by wired means (e.g., via a USB interface) or wireless means (e.g., via a Bluetooth interface). Other wired or wireless interfaces are possible as well, in accordance with other embodiments of the present invention. The personal computer 520 may be a desktop computer, a laptop computer, a notebook computer, or any other type of personal computer, in accordance with various embodiments of the present invention.

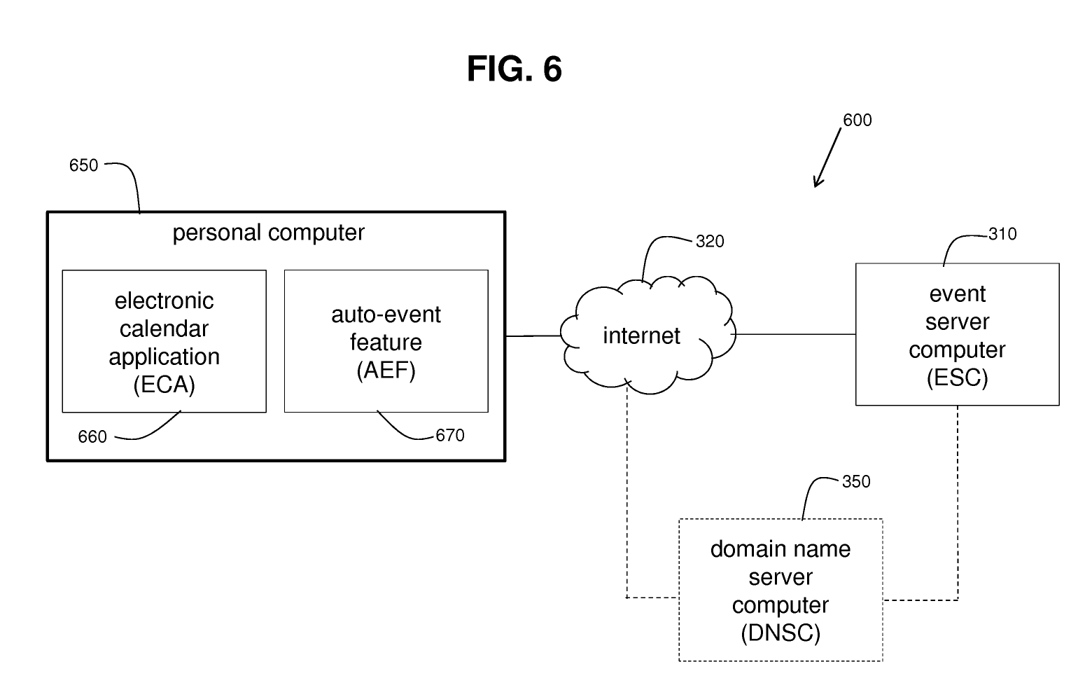

FIG. 6 illustrates an example embodiment of a communication network 600 and a personal computer 650 having an electronic calendar application 660 and an auto-event feature 670. The communication network 600 includes an event server computer (ESC) 310 operatively connected to the internet 320. As an option, as described previously herein, the communication network 600 may include a domain name server computer (DNSC) 350 operatively connected between the internet 320 and the event server computer (ESC) 310. The personal computer 650 is operatively connected to the internet 320 in a wired manner, as shown in FIG. 6. However, as an alternative, the personal computer 650 may be operatively connected to the internet 320 in a wireless manner, as is well-known in the art.

The AEF 670 functions in much the same way as previously described herein. However, with respect to providing an event-identifying code to the AEF 670, scanning or imaging the code using a personal computer may not be as practical as with a mobile telephone device. In the embodiment of FIG. 6, it may be more practical to enter the event-identifying code manually, via a keyboard of the personal computer 650, for example. Alternatively, the event-identifying code may be obtained by the personal computer 650 from an advertisement on a web site via the internet 320. For example, the event-identifying code could be electronically cut from the web site and electronically pasted into a displayed field of the AEF 670, for example. Again, in accordance with certain embodiments of the present application, the AEF may be an integral part of the ECA.

In accordance with other embodiments of the present invention, as event entries are created in an ECA by an AEF, the AEF may also be configured to communicate with other applications. For example, the AEF may provide event updates and/or notifications to friends via social network applications, emails, or text messaging. Furthermore, in accordance with other embodiments of the present invention, the ESC may be configured to recommend other events to the user based on the event-identifying code provided to the ESC. For example, a user that scans an event-identifying code for a particular musical concert may be provided with information by the ESC associated with other upcoming musical concerts. The AEF is configured to receive and display such recommended events to the user on the processor-based device.

In accordance with another embodiment of the present invention, the database of event information is located on the processor-based device. For example, a user of a processor-based device may download an event database from a web site of a city that the user is about to visit. Subsequently, when a user enters an event-identifying code associated with that city, the AEF scans that local database on the processor-based device for the event information, instead of connecting to a remote ESC.

In summary, devices, methods, servers, and non-transitory computer-readable medium for automatically generating an event entry within an electronic calendar application are disclosed. An event-identifying code of an advertised event is entered into an electronic auto-event feature running on a processor-based device. The auto-event feature may automatically access an event server via an information network in response to the event-identifying code and automatically retrieve event information associated with the advertised event from the event server via the information network based on at least a portion of the event-identifying code. Alternatively, the event information may be embedded in the event-identifying code. The auto-event feature is in operative communication with an electronic calendar application running on a processor-based device to automatically create at least one event entry for the advertised event within the electronic calendar application using at least a portion of the event information.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A method for automatically generating an event entry within an electronic calendar application, said method comprising:
entering an event-identifying code of an advertised event into an electronic auto-event feature running on a processor-based device;
said auto-event feature automatically accessing an event server via an information network in response to said event-identifying code;
said auto-event feature automatically retrieving event information associated with said advertised event from said event server via said information network based on at least a portion of said event-identifying code; and
said auto-event feature being in operative communication with an electronic calendar application running on a processor-based device to automatically create at least one event entry for said advertised event within said electronic calendar application using at least a portion of said event information.

2. The method of claim 1 wherein said electronic auto-event feature is in operative communication with said electronic calendar application on a same processor-based device.

3. The method of claim 2 wherein said electronic auto-event feature is an integral part of said electronic calendar application.

4. The method of claim 1 wherein said electronic auto-event feature is in operative communication with said electronic calendar application on a different processor-based device.

5. The method of claim 1 wherein the step of entering said event-identifying code includes electronically scanning said event-identifying code off of one of a printed advertisement and a displayed advertisement of said advertised event.

6. The method of claim 1 wherein the step of entering the event-identifying code includes:
electronically capturing an image of said event-identifying code off of one of a printed advertisement and a displayed advertisement of said advertised event; and
decoding the captured image.

7. The method of claim 1 wherein the step of entering the event-identifying code includes:
electronically capturing an image of said event-identifying code off of one of a printed advertisement and a displayed advertisement of said advertised event; and
optically character reading the captured image.

8. The method of claim 1 wherein the step of entering said event-identifying code includes manually keying said event-identifying code into said processor-based device running said electronic auto-event feature.

9. The method of claim 1 wherein said event-identifying code includes one of a one-dimensional bar code and a two-dimensional bar code.

10. The method of claim 1 wherein said event-identifying code includes alpha-numeric characters.

11. The method of claim 1 wherein the step of automatically creating at least one event entry for said advertised event within said electronic calendar application further uses a current location of a user of said auto-event feature to choose at least one location of said advertised event from said event information.

12. The method of claim 11 wherein said current location of said user is based on at least one of GPS information and cell tower information.

13. The method of claim 1 wherein the step of automatically creating at least one event entry for said advertised event within said electronic calendar application further uses a known address of a user of said auto-event feature to choose at least one location of said advertised event from said event information.

14. A non-transitory computer-readable medium having computer-executable instructions for enabling the performance of a method for automatically generating an event entry within an electronic calendar application comprising:
receiving an event-identifying code of an advertised event;
automatically accessing an event server via an information network in response to said event-identifying code;
automatically retrieving event information associated with said advertised event from said event server via said information network based on at least a portion of said event-identifying code; and
operatively communicating with an electronic calendar application running on a processor-based device to automatically create at least one event entry for said advertised event within said electronic calendar application using at least a portion of said event information.

15. The non-transitory computer readable medium of claim 14 wherein the event-identifying code is received as electronically scanned and decoded data.

16. The non-transitory computer readable medium of claim 14 wherein the event-identifying code is received as electronically imaged data.

17. The non-transitory computer readable medium of claim 14 wherein the event-identifying code is received as electronically imaged and decoded data.

18. The non-transitory computer readable medium of claim 14 wherein the event-identifying code is received as manually keyed electronic data.

19. The non-transitory computer readable medium of claim 14 wherein said event-identifying code includes one of a one-dimensional bar code and a two-dimensional bar code.

20. The non-transitory computer readable medium of claim 14 wherein said event-identifying code includes alpha-numeric characters.

21. The non-transitory computer readable medium of claim 14 wherein the method step of automatically creating at least one event entry for said advertised event within said electronic calendar application further uses a current location of a user of said electronic calendar application to choose at least one location of said advertised event from said event information.

22. The non-transitory computer readable medium of claim 21 wherein said current location of said user is based on at least one of GPS information and cell tower information.

23. The non-transitory computer readable medium of claim 14 wherein the method step of automatically creating at least one event entry for said advertised event within said electronic calendar application further uses a known address of a user of said electronic calendar application to choose at least one location of said advertised event from said event information.

24. An event server computer storing event information associated with advertised events, said event server computer hosting computer-executable instructions enabling the performance of a method comprising:
receiving an event-identifying code of an advertised event, via an information network, from an auto-event feature running on a processor-based device;
reading said event-identifying code and accessing stored first event information associated with at least a portion of said event-identifying code; and
sending said first event information to said auto-event feature via said information network, wherein said auto-event feature is configured to automatically create an event entry within an electronic calendar application based on said first event information.

25. The event server computer of claim 24 wherein said method further comprises:
receiving additional event information associated with other advertised events via said information network; and
storing said additional event information for subsequent accessing in response to subsequent event-identifying codes received from said auto-event feature.

26. The event server computer of claim 24 wherein said method further comprises deleting said first event information from said event server computer after said advertised event has occurred.

27. A processor-based device having computer-executable instructions configured as an auto-event feature for enabling the performance of a method for automatically generating an event entry within an electronic calendar application comprising:
receiving an event-identifying code of an advertised event;
automatically accessing an event server computer via an information network in response to said event-identifying code;
automatically retrieving event information associated with said advertised event from said event server computer via said information network based on at least a portion of said event-identifying code; and
operatively communicating with an electronic calendar application running on a processor-based device to automatically create at least one event entry for said advertised event within said electronic calendar application using at least a portion of said event information.

28. The processor-based device of claim 27 wherein the method step of receiving said event-identifying code includes electronically scanning said event-identifying code from a printed or displayed advertisement.

29. The processor-based device of claim 27 wherein the method step of receiving said event-identifying code includes electronically imaging said event-identifying code from a printed or displayed advertisement.

30. The processor-based device of claim 27 wherein the method step of receiving said event-identifying code includes manually keying said event-identifying code into said processor-based device.

31. The processor-based device of claim 27 wherein said event-identifying code includes one of a one-dimensional bar code and a two-dimensional bar code.

32. The processor-based device of claim 27 wherein said event-identifying code includes alpha-numeric characters.

33. The processor-based device of claim 27 wherein the method step of automatically creating at least one event entry for said advertised event within said electronic calendar application further uses a current location of a user of said processor-based device to choose at least one location of said advertised event from said event information.

34. The processor-based device of claim 33 wherein said current location of said user is based on at least one of GPS information and cell tower information obtained by said processor-based device.

35. The processor-based device of claim 27 wherein the method step of automatically creating at least one event entry for said advertised event within said electronic calendar application further uses a known address of a user of said processor-based device to choose at least one location of said advertised event from said event information.

36. The processor-based device of claim 27 wherein said processor-based device includes at least one of a mobile device, a cellular telephone, a laptop computer, and a desktop computer.

37. A method for automatically generating an event entry within an electronic calendar application, said method comprising:
entering an event-identifying code of an advertised event into an electronic auto-event feature running on a processor-based device, wherein said event-identifying code includes event information associated with said advertised event; and
said auto-event feature being in operative communication with an electronic calendar application running on a processor-based device to automatically create at least one event entry for said advertised event within said electronic calendar application using at least a portion of said event information.

38. The method of claim 37 wherein said electronic auto-event feature is in operative communication with said electronic calendar application on a same processor-based device.

39. The method of claim 38 wherein said electronic auto-event feature is an integral part of said electronic calendar application.

40. The method of claim 37 wherein said electronic auto-event feature is in operative communication with said electronic calendar application on a different processor-based device.

41. The method of claim 37 wherein the step of entering said event-identifying code includes electronically scanning said event-identifying code off of one of a printed advertisement and a displayed advertisement of said advertised event.

42. The method of claim 37 wherein the step of entering the event-identifying code includes:
electronically capturing an image of said event-identifying code off of one of a printed advertisement and a displayed advertisement of said advertised event; and
decoding the captured image.

43. The method of claim 37 wherein the step of entering the event-identifying code includes:
electronically capturing an image of said event-identifying code off of one of a printed advertisement and a displayed advertisement of said advertised event; and
optically character reading the captured image.

44. The method of claim 37 wherein the step of entering said event-identifying code includes manually keying said event-identifying code into said processor-based device running said electronic auto-event feature.

45. The method of claim 37 wherein said event-identifying code includes one of a one-dimensional bar code and a two-dimensional bar code.

46. The method of claim 37 wherein said event-identifying code includes alpha-numeric characters.

47. The method of claim 37 wherein the step of automatically creating at least one event entry for said advertised event within said electronic calendar application further uses a current location of a user of said auto-event feature to choose at least one location of said advertised event from said event information.

48. The method of claim 47 wherein said current location of said user is based on at least one of GPS information and cell tower information.

49. The method of claim 37 wherein the step of automatically creating at least one event entry for said advertised event within said electronic calendar application further uses a known address of a user of said auto-event feature to choose at least one location of said advertised event from said event information.

50. A non-transitory computer-readable medium having computer-executable instructions for enabling the performance of a method for automatically generating an event entry within an electronic calendar application comprising:
receiving an event-identifying code of an advertised event, wherein said event-identifying code includes event information associated with said advertised event; and
operatively communicating with an electronic calendar application running on a processor-based device to automatically create at least one event entry for said advertised event within said electronic calendar application using at least a portion of said event information.

51. The non-transitory computer readable medium of claim 50 wherein the event-identifying code is received as electronically scanned and decoded data.

52. The non-transitory computer readable medium of claim 50 wherein the event-identifying code is received as electronically imaged data.

53. The non-transitory computer readable medium of claim 50 wherein the event-identifying code is received as electronically imaged and decoded data.

54. The non-transitory computer readable medium of claim 50 wherein the event-identifying code is received as manually keyed electronic data.

55. The non-transitory computer readable medium of claim 50 wherein said event-identifying code includes one of a one-dimensional bar code and a two-dimensional bar code.

56. The non-transitory computer readable medium of claim 50 wherein said event-identifying code includes alpha-numeric characters.

57. The non-transitory computer readable medium of claim 50 wherein the method step of automatically creating at least one event entry for said advertised event within said electronic calendar application further uses a current location of a user of said electronic calendar application to choose at least one location of said advertised event from said event information.

58. The non-transitory computer readable medium of claim 57 wherein said current location of said user is based on at least one of GPS information and cell tower information.

59. The non-transitory computer readable medium of claim 50 wherein the method step of automatically creating at least one event entry for said advertised event within said electronic calendar application further uses a known address of a user of said electronic calendar application to choose at least one location of said advertised event from said event information.

60. A processor-based device having computer-executable instructions configured as an auto-event feature for enabling the performance of a method for automatically generating an event entry within an electronic calendar application comprising:
receiving an event-identifying code of an advertised event, wherein said event-identifying code includes event information associated with said advertised event; and
operatively communicating with an electronic calendar application running on a processor-based device to automatically create at least one event entry for said advertised event within said electronic calendar application using at least a portion of said event information.

61. The processor-based device of claim 60 wherein the method step of receiving said event-identifying code includes electronically scanning said event-identifying code from a printed or displayed advertisement.

62. The processor-based device of claim 60 wherein the method step of receiving said event-identifying code includes electronically imaging said event-identifying code from a printed or displayed advertisement.

63. The processor-based device of claim 60 wherein the method step of receiving said event-identifying code includes manually keying said event-identifying code into said processor-based device.

64. The processor-based device of claim 60 wherein said event-identifying code includes one of a one-dimensional bar code and a two-dimensional bar code.

65. The processor-based device of claim 60 wherein said event-identifying code includes alpha-numeric characters.

66. The processor-based device of claim 60 wherein the method step of automatically creating at least one event entry for said advertised event within said electronic calendar application further uses a current location of a user of said processor-based device to choose at least one location of said advertised event from said event information.

67. The processor-based device of claim 66 wherein said current location of said user is based on at least one of GPS information and cell tower information obtained by said processor-based device.

68. The processor-based device of claim 60 wherein the method step of automatically creating at least one event entry for said advertised event within said electronic calendar application further uses a known address of a user of said processor-based device to choose at least one location of said advertised event from said event information.

69. The processor-based device of claim 60 wherein said processor-based device includes at least one of a mobile device, a cellular telephone, a laptop computer, and a desktop computer.
